(19) United States
(12) Patent Application Publication
(10) Pub. No.: US 2026/0369924 A1
(43) Pub. Date: Nov. 19, 2026

(54) ELECTRICAL CONNECTOR DUST-PROOF STRUCTURE

(71) Applicant: V-General Technology Co., Ltd., Taoyuan City (TW)

(72) Inventors: Po-Wen YEH, Taoyuan City (TW); Tzu-Wei YEH, Taoyuan City (TW); Yu-Lun YEH, Taoyuan City (TW); Chien-Yeh LEE, Taoyuan City (TW)

(21) Appl. No.: 19/211,286

(22) Filed: May 19, 2025

(51) Int. Cl. H01R 13/52; H01R 13/6581

(52) U.S. Cl. CPC H01R 13/5213; H01R 13/6581

(57) ABSTRACT

An electrical connector dust-proof structure includes a shielding shell, a plurality of first movable joint portions, an insulation plastic body assembly, a transmission conductor set, a contact portion set, a connection portion set, a covering shell, a movable coupling portion, a sheltering portion, and at least one clearance portion. When the connection portion set of the transmission conductor set is connected to a circuit substrate, a user may inspect whether the position of the connection portion set is correct or not. When it is correct, the covering shell is rotatably moved by means of the pivotal connection of the movable coupling portion with each of the first movable joint portions to have the sheltering portion cover the connection portion set, and also make the connection portion set located in the clearance portion.

### BACKGROUND OF THE INVENTION

### (a) Technical Field of the Invention

The present invention relates to an electrical connector dust-proof structure that enables inspection of the position of a soldering portion of a transmission conductor set and also has a dust-proof function, and also meet the French Repairability Index.

### (b) Description of the Prior Art

A contact end of a connector is usually covered with an iron shell to cut off the electromagnetic interference generated by electronic components and prevent influence on the device including the electronic components and other surrounding electronic devices. However, the iron shell must be partially hollowed out due to its structure and operation, and this greatly reduces the shielding effect. In addition, a soldering end of the connector cannot be shielded by the iron shell because of being soldered on a circuit board. Therefore, the soldering end of the connector is often designed with a rear cover. For example, Taiwan Utility Model M634751 “Covering Structure of Electrical Connector” uses a separate metal rear cover, achieving the purposes of facilitating soldering, easy inspection and maintenance, reducing interference, suppressing noise, and expanding grounding circuit.

However, the above-discussed covering structure of electrical connector exhibits, during use thereof, the following defects that require further improvement:

Although there are the advantages of facilitating soldering, easy inspection and maintenance, reducing interference, suppressing noise, and expanding grounding circuit, in fact, the main purposes are just reducing interference and suppressing noise, and it is definitely not easy for inspection and maintenance status. The reason is that the metal rear cover is set to close after the soldering portion is soldered to a circuit board, and the metal rear cover is fixed to an insulation body through the buckling of the insulation body and a second joint portion. This will make it difficult for the metal rear cover to be easily separated from the insulation body. Even if it can be separated, the metal rear cover may be lost because the metal rear cover is completely separated from the insulation body, and this is also less convenient in terms of maintenance.

### SUMMARY OF THE INVENTION

The primary objective of the present invention is to make a connection portion set not easily attached with dust by means of an arrangement of a sheltering portion of a covering shell, so as to effectively avoid shorting problems, and to allow a connection portion set to perfectly hide in the covering shell by means of an arrangement of a clearance portion, not only beautiful, but also achieving an effect of dust-proofness.

Another objective of the present invention is that through the connected arrangement of first movable joint portions and a movable coupling portion, the electrical connector of the present invention is equipped with a covering shell, so that a user can intuitively operate the covering shell to cover the connection portion set without additionally assembling the covering shell after inspecting the connection portion set, and such a structural feature can increase the speed of covering and also prevent the covering shell from being lost.

The structure that the present invention adopts to achieve the above objectives comprises a shielding shell, a plurality of first movable joint portions, an insulation plastic body assembly, a transmission conductor set, a contact portion set, a connection portion set, a covering shell, a movable coupling portion, a sheltering portion, and at least one clearance portion, wherein the shielding shell comprises first movable joint portions, the insulation plastic body assembly being received in the shielding shell, the transmission conductor set being mounted on the insulation plastic body assembly and comprising the contact portion set and the connection portion set extending from one end of the contact portion set for contacting a circuit substrate, the covering shell comprising a movable coupling portion connected with each of the first movable joint portions, a sheltering portion extending from the movable coupling portion and covering the connection portion set, and a clearance portion formed by being surrounded by the sheltering portion.

When the connection portion set of the transmission conductor set is connected to a circuit substrate, a user may inspect whether the position of the connection portion set is correct or not. When it is correct, the covering shell is rotatably moved by means of the pivotal connection of the movable coupling portion with each of the first movable joint portions. When the sheltering portion completely covers the connection portion set, the connection portion set is located in the clearance portion. In this way, when a counterpart electrical connector and the contact portion set are inserted into each other to conduct with each other, the shielding shell can suppress noise and interference, and the insulation plastic body assembly can stabilize the transmission operation of the transmission conductor set. In addition, the covering shell can prevent dust from attaching to the connection portion set due to static electricity to cause problems of shorting during the process of transmission.

By using the above technology, the problem of the prior art that the covering structure of an electrical connector, although having the advantages of facilitating soldering, easy inspection and maintenance, reducing interference, suppressing noise, and expanding grounding circuit, yet in fact, the main purposes are just reducing interference and suppressing noise and it is definitely not easy for inspection and maintenance status for the reasons that the metal rear cover is set to close after the soldering portion is soldered to a circuit board, and the metal rear cover is fixed to an insulation body through the buckling of the insulation body and a second joint portion thereby making it difficult for the metal rear cover to be easily separated from the insulation body, and even being possible to separate, the metal rear cover may get loss due to the metal rear cover being completely separated from the insulation body to become less convenient in terms of maintenance can be overcome to achieve the practical improvement of the above-mentioned advantages of the present invention.

### BRIEF DESCRIPTION OF THE DRAWINGS

FIG. 1 is a perspective see-through view showing a first preferred embodiment of the present invention.

FIG. 2 is a perspective exploded view, taken from a different angle, showing the first preferred embodiment of the present invention.

FIG. 3 is a schematic view illustrating opening of the first preferred embodiment of the present invention.

FIG. 4 is a schematic view illustrating closing of the first preferred embodiment of the present invention.

FIG. 5 is an exploded view showing a second preferred embodiment of the present invention.

FIG. 6 is a perspective view showing a third preferred embodiment of the present invention.

FIG. 7 is a perspective exploded view, taken from a different angle, showing the third preferred embodiment of the present invention.

FIG. 8 is a schematic view illustrating opening of the third preferred embodiment of the present invention.

FIG. 9 is a schematic view illustrating closing of the third preferred embodiment of the present invention.

FIG. 10 is an exploded view showing a fourth preferred embodiment of the present invention.

FIG. 11 is a cross-sectional view showing a fifth preferred embodiment of the present invention.

FIG. 12 is a perspective view showing a sixth preferred embodiment of the present invention.

FIG. 13 is a perspective view showing a seventh preferred embodiment of the present invention.

FIG. 14 is a perspective view showing an eighth preferred embodiment of the present invention.

### DETAILED DESCRIPTION OF THE PREFERRED EMBODIMENTS

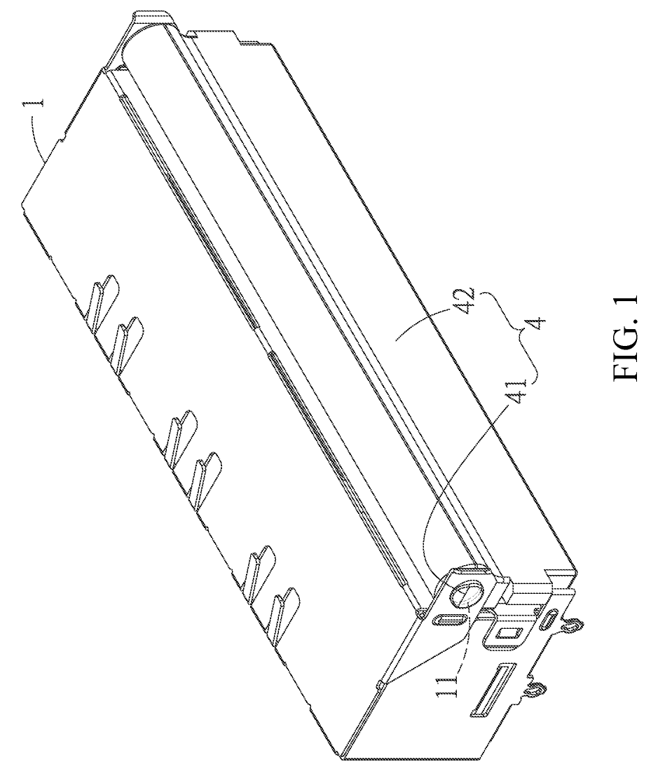

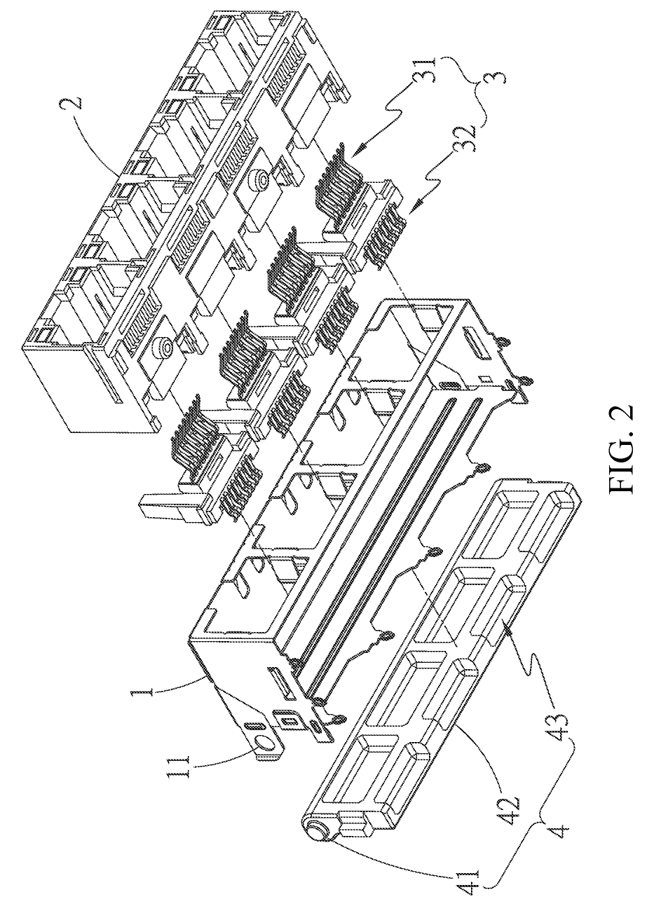

Referring to FIGS. 1 and 2, which are respectively a perspective see-through view of a first preferred embodiment of the present invention and a perspective exploded view thereof taken from a different angle, it is clearly seen from the drawings that the present invention comprises:
a shielding shell 1, which comprises a plurality of first movable joint portions 11;
an insulation plastic body assembly 2, which is received in the shielding shell 1; a transmission conductor set 3, which is mounted on the insulation plastic body assembly 2 and comprises a contact portion set 31 and a connection portion set 32 extending from one end of the contact portion set 31 for contacting a circuit substrate, the connection portion set 32 being located at a lower side of each of the first movable joint portions 11; and
a covering shell 4, which comprises a movable coupling portion 41 connected with each of the first movable joint portions 11, a sheltering portion 42 extending from the movable coupling portion 41 and covering the connection portion set 32, and at least one clearance portion 43 formed by being surrounded by the sheltering portion 42, so that the covering shell 4 is rotatably movable by means of pivotal connection of the movable coupling portion 41 with each of the first movable joint portions 11, and when the sheltering portion 42 completely covers the connection portion set 32, the connection portion set 32 is located inside the clearance portion 43.

In the above, in the instant embodiment, a shaft hole is taken as an example for illustrating the first movable joint portions 11, and terminals of a registered jack (RJ) connector are taken as an example for illustrating the transmission conductor set 3, and cantilever arms having elasticity are taken an example for illustrating the contact portion set 31 and the connection portion set 32, and the covering shell 4 is an insulation body, and the insulation body can be plastics, and a cylindrical body is taken as an example for illustrating the movable coupling portion 41, and as an example for illustration, the sheltering portion 42 is arranged as a sidewall of the covering shell 4, and as an example for illustration, the clearance portion 43 is a recessed trough and has four such troughs.

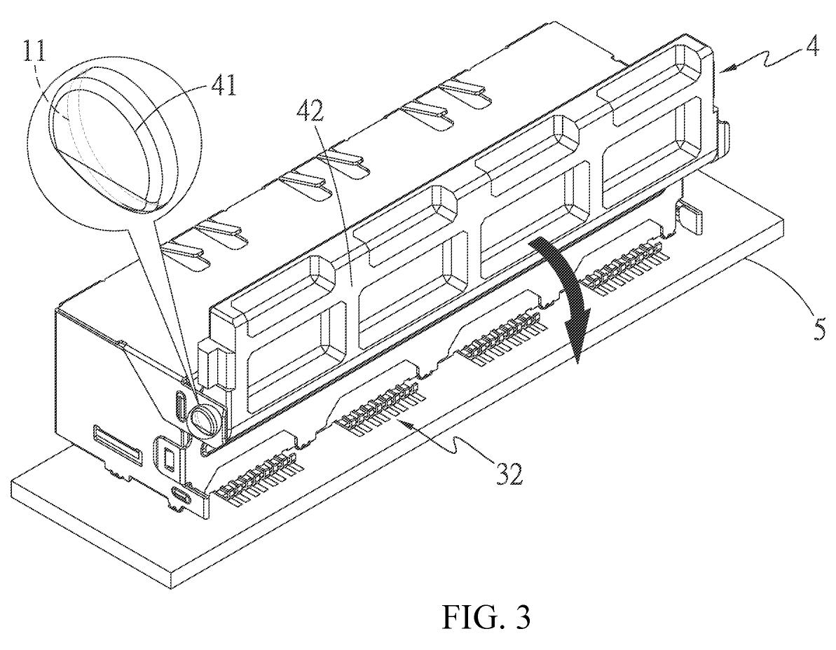

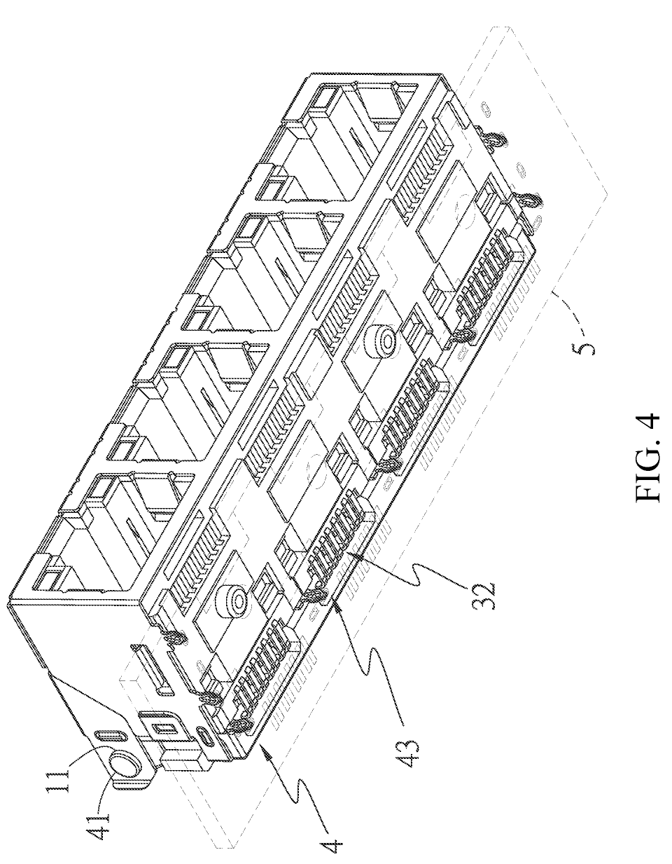

Referring to FIGS. 1-4, which are a perspective see-through view of the first preferred embodiment of the present invention to a schematic view illustrating closing thereof, it is clearly seen from the drawings that when the electrical connector is shipped out of the manufacturing factory, each of the first movable joint portions 11 is already set in pivotal connection with the movable coupling portion 41 in advance. Therefore, when the electrical connector is set on a circuit substrate 5 and the connection portion set 32 is connected to the circuit substrate 5, the sheltering portion 42 of the covering shell 4 is in an open state, so that a user may easily observe the condition of connection of the connection portion set 32 with the circuit substrate 5, such as the setting position being correct or not. After the inspection is completed, the covering shell 4 can be flipped down from the open state to a closed state. During the process, the covering shell 4 may rotate for approximately 180 degrees by means of the pivotal connection of the movable coupling portion 41 and the first movable joint portions 11. Therefore, when the covering shell 4 is in the closed state, the sheltering portion 42 covers the connection portion set 32, and the connection portion set 32 is hidden in the clearance portion 43, so that the connection portion set 32 is completely covered to prevent the occurrence of an electrostatic reaction induced by conduction between a counterpart electrical connector and the contact portion set 31 of the transmission conductor set 3 that makes external dust easily attached to the connection portion set 32, so as to effectively avoid a shorting phenomenon occurring on the connection portion set 32 or signal interference problems.

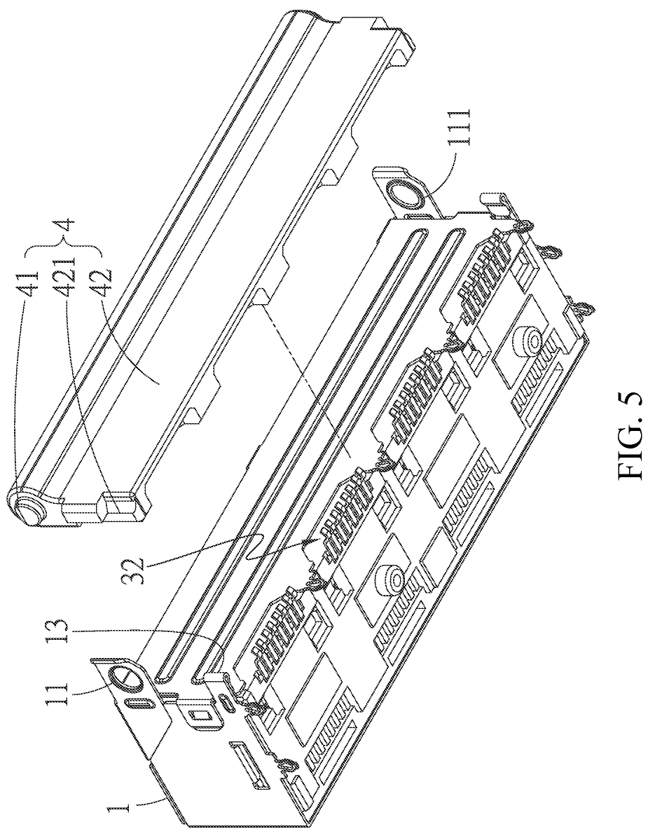

Referring to FIG. 5, which is an exploded view of a second preferred embodiment of the present invention, it is clearly seen from the drawing that a difference of the instant embodiment from the previous embodiment resides in that each of the first movable joint portions 11 is provided, on an inner side thereof, with a protrusion portion 111 for tightening the movable coupling portion 41, and the shielding shell 1 is provided, on the side thereof away from each of the first movable joint portions 11, with a snap engagement portion 13, and the sheltering portion 42 is provided, on the side thereof away from the movable coupling portion 41, with a snap fitting portion 421 that is engageable with the snap engagement portion 13, wherein the snap engagement portion 13 and the snap fitting portion 421 are both exemplified by relatively protruding thickness, so that when the covering shell 4 is flipped over to the open state, the covering shell 4 is affected by the arrangement of the protrusion portion 111 to have the covering shell 4 pressed by the protrusion portion 111 to maintain in the open state and does not fall freely, achieving convenience of inspection of the connection portion set 32 without using hand to open, and when the covering shell 4 in the closed state, the snap engagement portion 13 and the snap fitting portion 421 are in retaining engagement with each other, so that the covering shell 4 cannot be easily opened particularly when the electrical connector is shaken.

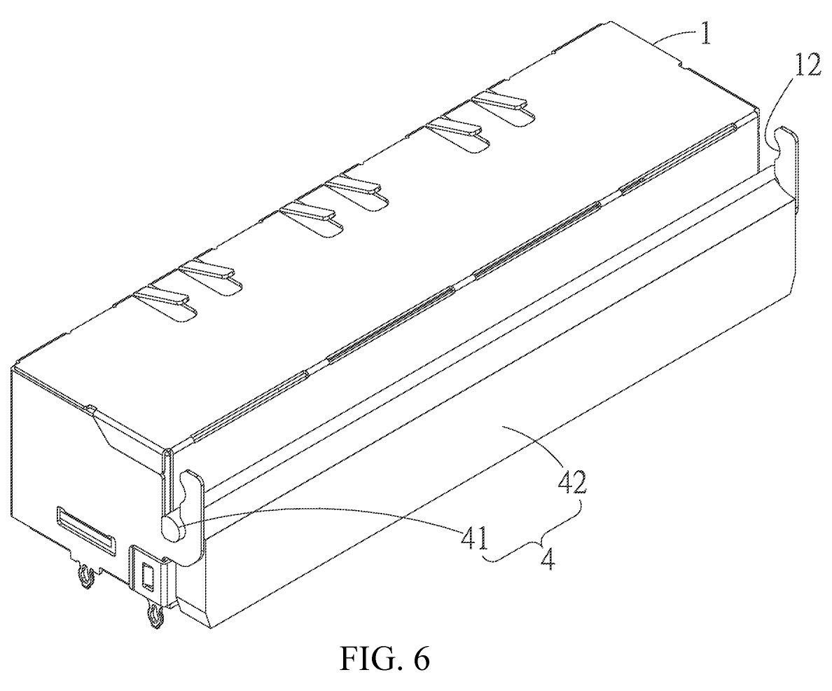

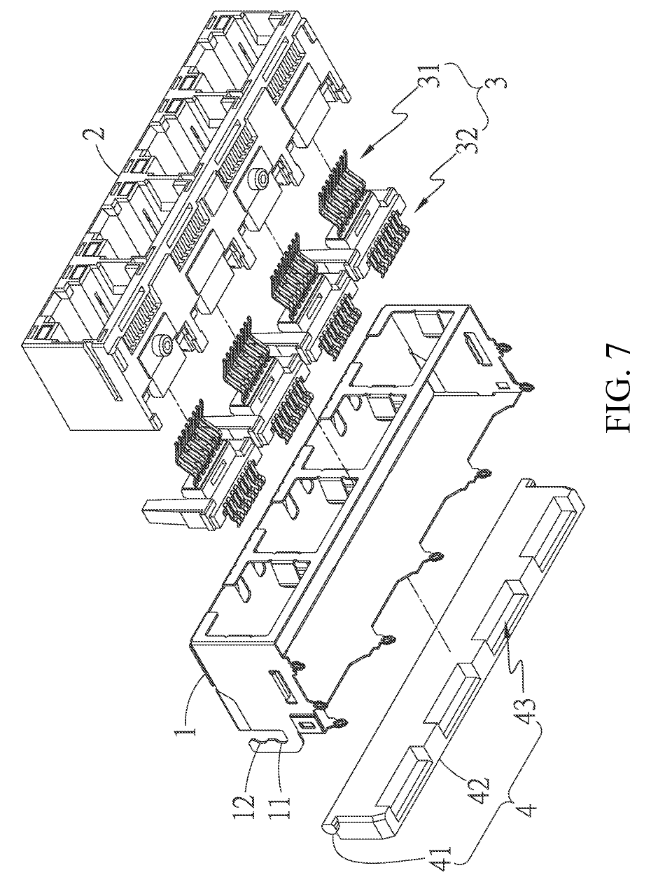

Referring to FIGS. 6 and 7, which are a perspective view of a third preferred embodiment of the present invention and a perspective exploded view thereof taken from a different angle, it is clearly seen from the drawings that the present invention comprises:
a shielding shell 1, which comprises a plurality of first movable joint portions 11 and a plurality of second movable joint portions 12 respectively located at one side of each of the first movable joint portions 11, wherein each of the first movable joint portions 11 is in communication with each of the second movable joint portions 12;
an insulation plastic body assembly 2, which is received in the shielding shell 1; a transmission conductor set 3, which is mounted on the insulation plastic body assembly 2 and comprises a contact portion set 31 and a connection portion set 32 extending from one end of the contact portion set 31 for contacting a circuit substrate, the connection portion set 32 being located at a lower side each of the first movable joint portions 11; and
covering shell 4, which comprises a movable coupling portion 41 movably arranged on each of the first movable joint portions 11 and each of the second movable joint portions 12, a sheltering portion 42 extending from the movable coupling portion 41 and covering the connection portion set 32, and at least one clearance portion 43 formed by being surrounded by the sheltering portion 42, so that the covering shell 4 uses movement of the movable coupling portion 41 between each of the first movable joint portions 11 and each of the second movable joint portions 12 to make the sheltering portion 42 cover or not cover the connection portion set 32, and when the sheltering portion 42 completely covers the connection portion set 32, the connection portion set 32 is located inside the clearance portion 43.

In the above, in the instant embodiment, notches are taken as an example for illustrating the first movable joint portions 11 and the second movable joint portions 12, and terminals of an RJ connector are taken as an example for illustrating the transmission conductor set 3, and cantilever arms having elasticity are taken as an example for illustrating the contact portion set 31 and the connection portion set 32, and the covering shell 4 is an insulation body, and the insulation body can be plastics, and a cylindrical body is taken as an example for illustrating the movable coupling portion 41, and as an example for illustration, the sheltering portion 42 is arranged as a sidewall of the covering shell 4, and as an example for illustration, the clearance portion 43 is a recessed trough and has just one such trough.

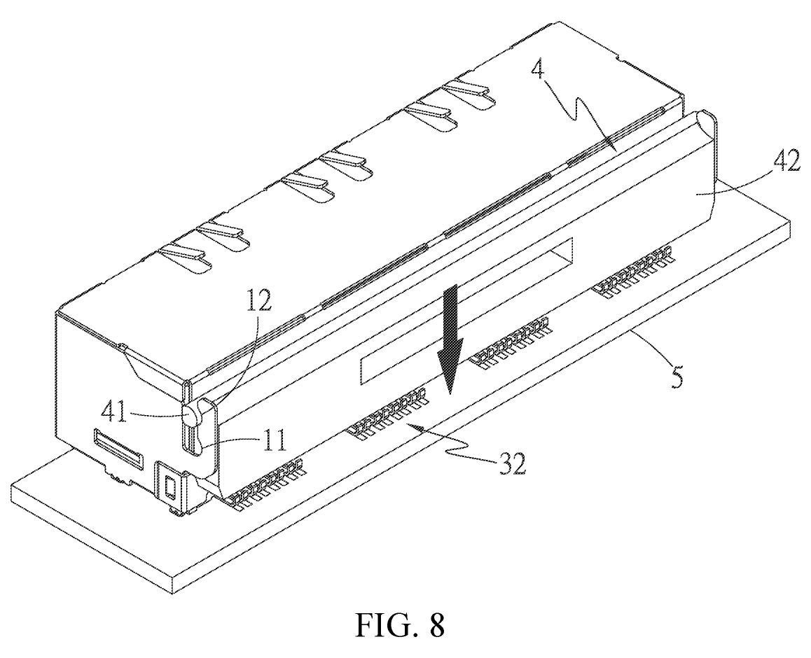

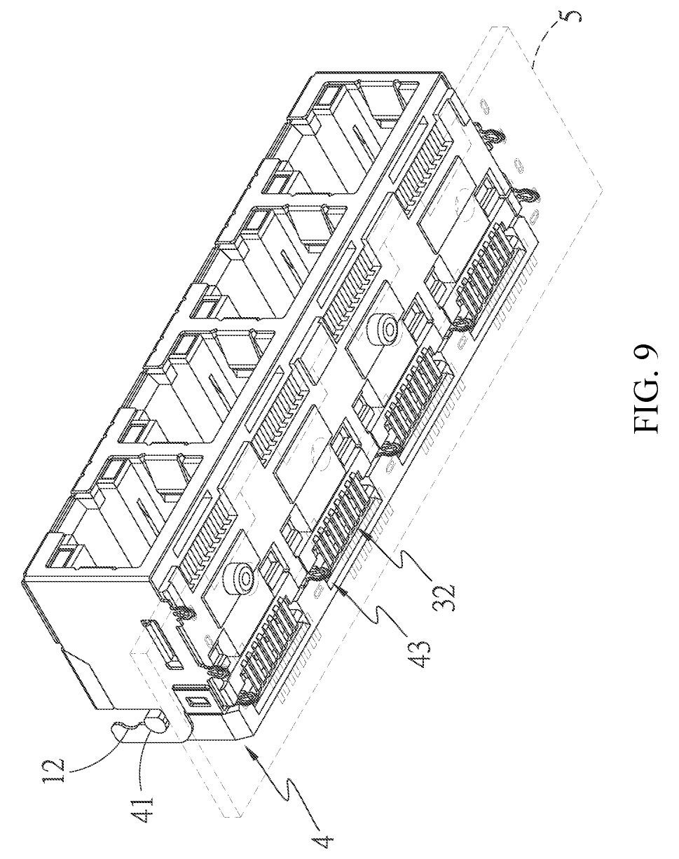

Referring to FIGS. 6-9, which are a perspective view of the third preferred embodiment of the present invention to a schematic view illustrating closing thereof, it is clearly seen from the drawings that when the electrical connector is shipped out of the manufacturing factory, each of the second movable joint portions 12 is already set in connection with the movable coupling portion 41 in advance, but not locked. Therefore, when the electrical connector is set on a circuit substrate 5 and the connection portion set 32 is connected to the circuit substrate 5, the movable coupling portion 41 of the covering shell 4 is located on the second movable joint portions 12, setting the sheltering portion 42 in an open state, so that a user may easily observe the condition of connection of the connection portion set 32 with the circuit substrate 5, such as the setting position being correct or not. After the inspection is completed, the covering shell 4 is vertically moved down from the open state to the closed state. During the process, the movable coupling portion 41 is moved from the original location of being on the second movable joint portions 12 to the first movable joint portions 11 to set the covering shell 4 in the closed state, where the sheltering portion 42 covers the connection portion set 32 and the connection portion set 32 is hidden in the clearance portion 43, so that the connection portion set 32 is completely covered to prevent the occurrence of an electrostatic reaction induced by conduction between a counterpart electrical connector and the transmission conductor set 3 that makes external dust easily attached to the connection portion set 32, so as to effectively avoid a shorting phenomenon occurring on the connection portion set 32 or signal interference problems.

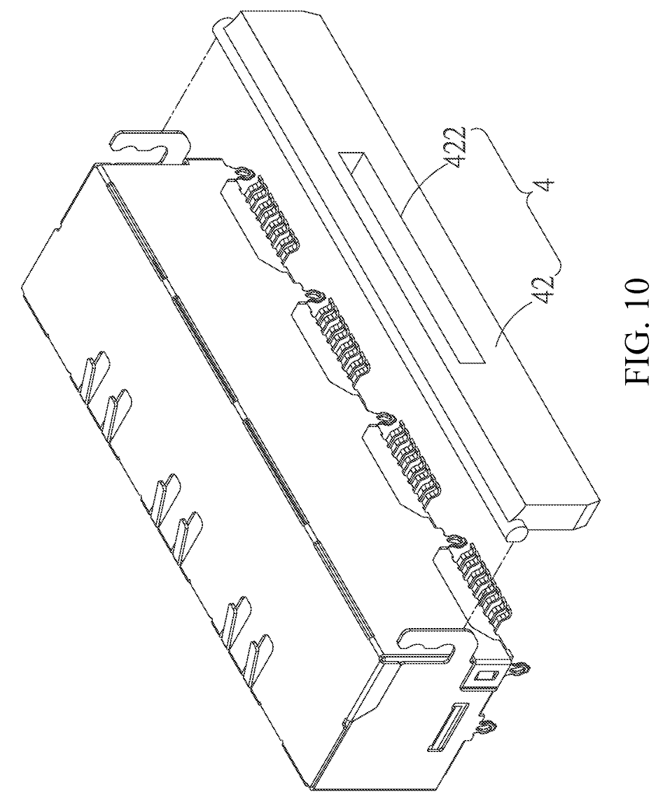

Referring to FIG. 10, which is an exploded view of a fourth preferred embodiment of the present invention, it is clearly seen from the drawing that the instant embodiment is different from the third embodiment in that the sheltering portion 42 of the covering shell 4 is formed with a grip portion 422, wherein the grip portion 422 is exemplified in the instant embodiment by a recessed groove, and can of course be a protruding grip, and generally, there is no limitation to the outside appearance thereof. When the user attempts to open the covering shell 4 upward, a tool is penetrating into the grip portion 422 to lift upward and open the covering shell 4, achieving an advantage of using the grip portion 422 to easily open the covering shell 4.

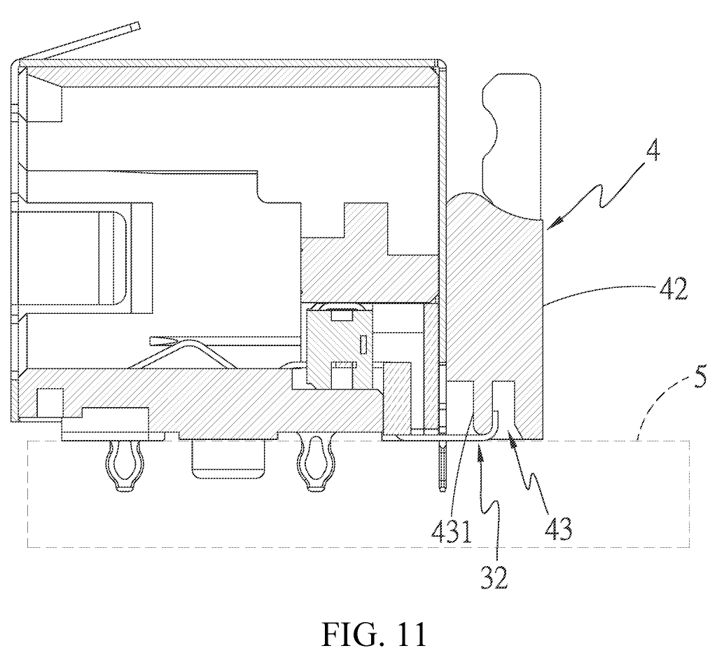

Referring to FIG. 11, which is a cross-sectional view of a fifth preferred embodiment of the present invention, it is clearly seen from the drawing that the instant embodiment is different from the third embodiment in that a pressing portion 431 is arranged in the clearance portion 43 in order to press against the connection portion set 32 when the sheltering portion 42 completely covers the connection portion set 32, wherein the pressing portion 431 is exemplified in the instant embodiment by a protrusion portion. When the covering shell 4 moves downward from the top side, the pressing portion 431 will contact the connection portion set 32, and when the covering shell 4 completes the operation of covering, the pressing portion 431 presses the connection portion set 32 downward to make the connection portion set 32 more firmly contact the circuit substrate 5 and prevent the problem of micro-contact between the connection portion set 32 and the circuit substrate 5, because micro-contact may cause problems of packet loss occurring on the transmission conductor set during high speed transmission, resulting in incomplete signal. Thus, by means of the arrangement of the pressing portion 431, packet loss can be prevented, making the signal more complete.

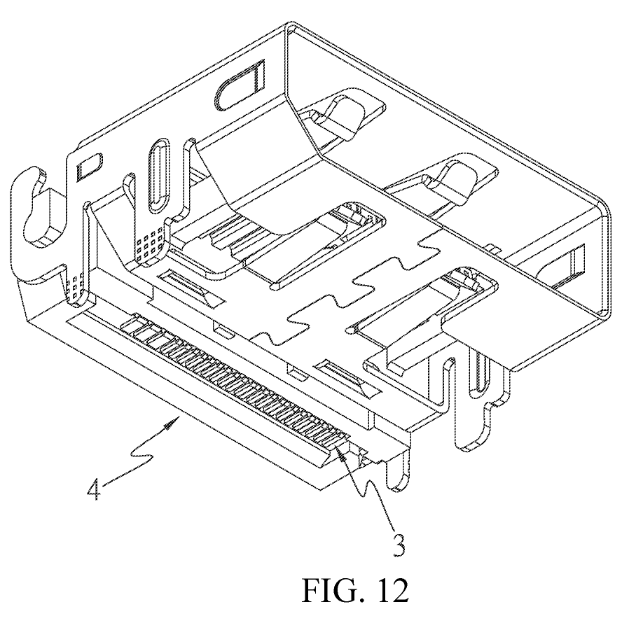

Referring to FIG. 12, which is a perspective view of a sixth preferred embodiment of the present invention, it is clearly seen from the drawing that the instant embodiment is different from the third embodiment in that in the instant embodiment, the transmission conductor set 3 is changed from the terminals of an RJ connector to a DisplayPort (DP) connector, indicating the electrical connectors to which the present invention is applicable are particularly wide, and all can use the covering shell 4 for dust-proofing and easy inspection.

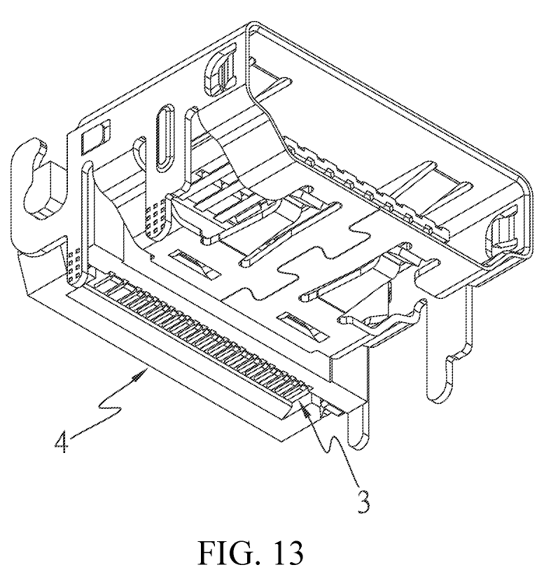

Referring to FIG. 13, which is a perspective view of a seventh preferred embodiment of the present invention, it is clearly seen from the drawing that the instant embodiment is different from the third embodiment in that in the instant embodiment, the transmission conductor set 3 is changed from the terminals of an RJ connector to a High Definition Multimedia Interface (HDMI) connector, indicating the electrical connectors to which the present invention is applicable are particularly wide, and all can use the covering shell 4 for dust-proofing and easy inspection.

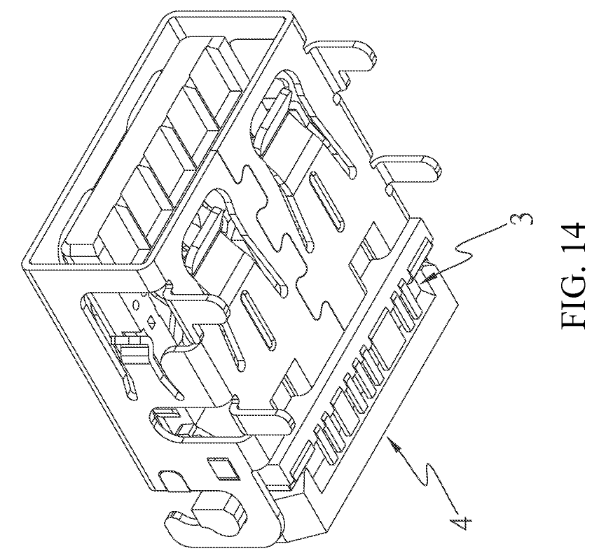

Referring to FIG. 14, which is a perspective view of an eighth preferred embodiment of the present invention, it is clearly seen from the drawing that the instant embodiment is different from the third embodiment in that in the instant embodiment, the transmission conductor set 3 is changed from the terminals of an RJ connector to a Universal Serial Bus (USB) Type A connector, indicating the electrical connectors to which the present invention is applicable are particularly wide, and all can use the covering shell 4 for dust-proofing and easy inspection.

I claim:

1. An electrical connector dust-proof structure, comprising:
a shielding shell, which comprises a plurality of first movable joint portions;
an insulation plastic body assembly, which is received in the shielding shell;
a transmission conductor set, which is mounted on the insulation plastic body assembly and comprises a contact portion set and a connection portion set extending from one end of the contact portion set for contacting a circuit substrate, the connection portion set being located at a lower side of each of the first movable joint portions; and
a covering shell, which comprises a movable coupling portion connected with each of the first movable joint portions, a sheltering portion extending from the movable coupling portion and covering the connection portion set, and at least one clearance portion formed by being surrounded by the sheltering portion, so that the covering shell is rotatably movable by means of pivotal connection between the movable coupling portion and each of the first movable joint portions, and when the sheltering portion completely covers the connection portion set, the connection portion set is located in the clearance portion.

2. The electrical connector dust-proof structure according to claim 1, wherein ach of the first movable joint portions is provided, on an inner side thereof, with a protrusion portion for tightening the movable coupling portion.

3. The electrical connector dust-proof structure according to claim 1, wherein the shielding shell is provided, on one side thereof away from each of the first movable joint portions, with a snap engagement portion, and the sheltering portion is provided, on one side thereof away from the movable coupling portion, with a snap fitting portion that is engageable with the snap engagement portion.

4. The electrical connector dust-proof structure according to claim 1, wherein the covering shell comprises an insulation body.

5. An electrical connector dust-proof structure, comprising:
a shielding shell, which comprises a plurality of first movable joint portions and a plurality of second movable joint portions respectively located at one side of each of the first movable joint portions, wherein each of the first movable joint portions is in communication with each of the second movable joint portions;
an insulation plastic body assembly, which is received in the shielding shell;
a transmission conductor set, which is mounted on the insulation plastic body assembly and comprises a contact portion set and a connection portion set extending from one end of the contact portion set for contacting a circuit substrate, the connection portion set being located at a lower side of each of the first movable joint portions; and
a covering shell, which comprises a movable coupling portion movably arranged on each of the first movable joint portions and each of the second movable joint portions, a sheltering portion extending from the movable coupling portion and covering the connection portion set, and at least one clearance portion formed by being surrounded by the sheltering portion, so that the covering shell uses movement of the movable coupling portion between each of the first movable joint portions and each of the second movable joint portions to make the sheltering portion cover or not cover the connection portion set, and when the sheltering portion completely covers the connection portion set, the connection portion set is located in the clearance portion.

6. The electrical connector dust-proof structure according to claim 5, wherein the sheltering portion is formed with a grip portion.

7. The electrical connector dust-proof structure according to claim 5, wherein a pressing portion is provided in the clearance portion in order to press against the connection portion set when the sheltering portion completely covers the connection portion set.

8. The electrical connector dust-proof structure according to claim 5, wherein the covering shell comprises an insulation body.
